(19) United States
(12) Patent Application Publication
(10) Pub. No.: US 2020/0104696 A1
(43) Pub. Date: Apr. 2, 2020

(54) SERVICE ACCOUNT PREDICTION USING USER NAME

(71) Applicant: MICROSOFT TECHNOLOGY LICENSING, LLC, Redmond, WA (US)

(72) Inventors: Richard Patrick Lewis, Lynnwood, WA (US); Lisa Deng, Cambridge, MA (US); Craig Henry Wittenberg, Clyde Hill, WA (US); Daniel Lee Mace, Bellevue, WA (US); Yogesh Kant Roy, Redmond, WA (US)

(21) Appl. No.: 16/146,356

(22) Filed: Sep. 28, 2018

(51) Int. Cl. G06N 3/08; G06F 21/31; G06F 21/56

(52) U.S. Cl. CPC G06N 3/08; G06F 2221/034; G06F 21/561; G06F 21/31

(57) ABSTRACT

Systems are provided for using machine learning to identify service accounts and/or for distinguishing service accounts from user accounts based on the user names of the accounts. Machine learning tools can be trained on user name label data for service accounts and user accounts. The trained machine learning tool can then be applied to user names of accounts to determine whether the user names correspond to service accounts or not and, in some instances, without referencing tables or other structures that explicitly identify and distinguish the service/user accounts and/or conventions for identifying service accounts. Then, the systems can respond appropriately, based on the determination. The machine learning tool can also be shared with other systems to make the same determinations for their accounts without having to share confidential or proprietary account information.

### BACKGROUND

Computers and corresponding software applications are becoming increasingly sophisticated, enabling users to store, access and manipulate data in a variety of ways. For instance, computer applications can be used to perform word processing, graphic design, audio/visual processing, data analytics, electronic communications, and much more.

User accounts are often utilized by computer systems to control the manner in which their resources are accessed and utilized. This is particularly true for distributed computer systems, which enable users to remotely log into their user accounts through web browsers and other cloud portals by entering account credentials, such as a user name and password, to identify the user's account and the corresponding rights and permissions associated with that user account.

User accounts are often used by users to access and utilize computer resources comprising services which utilize service accounts to perform their services. For instance, service accounts can be configured to perform specific computer services, such as mail services, data storage services, data processing services, communication services or other computer services.

User accounts are also sometimes used by automated services to provide credentials to authenticate these services to access other resources and services. A service account is used by an automated service to authenticate that service in a manner similar to how a human user would be authenticated.

As will be appreciated from the foregoing, service accounts can sometimes have greater exposure and control in a computer system than conventional user accounts. For instance, a single service account can be used to run or otherwise facilitate mail transport services for a plurality of different user accounts. Likewise, a single service account can be used to perform a database management service for an entire datastore of restricted data that is associated with a plurality of different user accounts. As another example, service accounts can be configured with permissions for accessing and modifying the configuration files of an operating system that services multiple different user accounts.

Computer systems, particularly large and/or distributed computing systems, may be configured to utilize a plurality of different service accounts. Each set of the one or more service accounts can also be assigned to different service domains for improving overall system performance and for helping to define resources that can be utilized by the services.

System policies and permissions assigned to the service accounts, just like conventional user accounts, can restrict and control the manner in which the service accounts access and utilize computer resources. Oftentimes, the security policies applied to service accounts and user accounts will be different to help ensure that the different accounts are afforded the appropriate controls and access rights pertaining to their corresponding users and services, and while also ensuring the security risks associated with the different types of accounts are managed appropriately.

When an account requests access to a computer resource, or when a particular behavior is detected for an account, the associated computer system will often determine whether that account is a user account or a service account, so that the appropriate policies and permissions will be applied when determining whether to respond to the requested access or detected behavior. Likewise, the determination of how a resource is used or manipulated by an account can also be based on the determination of whether that account is a user account or a service account.

Unfortunately, it can sometimes be difficult for a computing system to distinguish between user accounts and service accounts. This is because service accounts, which are typically provisioned as a special type of user account, have the same essential characteristics as user accounts, including account credentials (e.g., user name and password) and other user account properties such as defined user rights/permissions.

In an effort to help differentiate between service accounts and user accounts, the service accounts can be explicitly tagged or modified with identifiers, such as a particular keyword, integer, flag, or other metadata that is associated with the service account. However, there is no established or uniform convention for making such an explicit identification of a service account. For instance, some developers might set a predetermined property value for the service accounts to particular integer value, and other developers might recite the actual term ‘service’ within the account name or definition of the service account, while yet other developers might set the passwords for service accounts to particular default values, and so forth. In fact, there is virtually no limit to the different types of conventions and identifiers that can be used to identity a service account, making it very difficult to know how to identify and distinguish service accounts from user accounts.

The difficulty in distinguishing between user accounts and service accounts is even more pronounced for large and/or distributed systems that are associated with a high volume and variety of accounts created over an extended period of time by different users and developers utilizing different naming and provisioning conventions for the accounts.

The inability of a computer system to distinguish service accounts from user accounts can make it particularly difficult to ensure the appropriate policies and controls are applied to the different accounts, such as, for example, when a computing system needs to determine an appropriate response to a detected request or behavior that is deemed risky. For instance, by way of example, a computer system might detect multiple requests originating from a single account, which are received contemporaneously from different devices in different locations. If the account is a user account, this could indicate a risk scenario involving leaked user credentials and an appropriate response might be to deny the request, lock the account, or trigger a multifactor authentication. Alternatively, if the account is a service account, the potential risk scenario could be dismissed because it would not be unexpected (e.g., the request could be a web service request to update content displayed in a browser on multiple devices). Clearly, the multifactor authentication would not be necessary or appropriate in such a scenario.

In another example, if a virus signature is detected in a request received from an account that is determined to be a user account, the appropriate response might be to simply deny the request and to quarantine that particular account. However, if the request was received from a service account, a more extensive and urgent response might be necessary to help prevent catastrophic systemwide failures, including the scanning of all components and accounts serviced by the service account and modifying the permissions associated with that service account.

It will be appreciated that, in view of at least the foregoing, there is an ongoing need to improve the manner in which computer systems identify and differentiate between user accounts and service accounts and particularly for legacy systems that utilize different classifying conventions for distinguishing between user accounts and service accounts.

Despite the foregoing description, it will be appreciated that the subject matter of the disclosed embodiments is not limited to only embodiments that solve the particular disadvantages, or that operate only in environments such as those described above. Rather, this background is only provided to illustrate one exemplary technology area where some embodiments described herein may be practiced.

### BRIEF SUMMARY

Disclosed embodiments include systems and methods for facilitating the manner in which service accounts are identified and distinguished from user accounts and, even more particularly, to systems and methods for making service account identifications and predictions based on the user names of the service accounts.

In some embodiments, a computer system identifies a user name of an account. This identification can be made during a login process involving the account, in response to detecting a request from the account, in response to detecting a particular behavior of the account, in response to a query from a third party, or in response to another event.

Once the computer system identifies the user name of the account, it makes the prediction of whether the corresponding account is a service account by applying the user name of the account to a trained machine learning tool that was trained on user name label data for service accounts and user accounts. In some instances, this is accomplished without referencing a listing of user accounts or service accounts (or the conventions for identifying service accounts) from a reference table or other data structure. Once the determination is made whether the user name corresponds to a service account (or alternatively to a user account), the computer system can respond appropriately, such as by notifying another entity that the account is a service account, triggering an event that is selectively based on the account being a service account, providing a service or resource based on the account being determined to be a service account, and so forth.

In related embodiments, the determination of account type can be made in response to detecting an account behavior or receiving a request from the account. In these embodiments, the computer system makes the prediction of whether the particular account associated with the detected behavior or request is a service account by applying a user name of the account to a trained machine learning tool that was trained on account name label data of service accounts and user accounts, by the same system or a different system that detects the behavior or request. As before, this may be accomplished while refraining from referencing a listing of user accounts or service accounts, or conventions for identifying service accounts, from a reference table or any other data structure. Then, in response to determining the request/behavior corresponds to a user account or a service account, the system provides an appropriate response, such as by providing output that explicitly identifies the type of the account, by triggering an event that is deterministically based on whether the account is a service account or a user account, by providing a requested service or resource, or another event/response.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a computing environment that is used to train a machine learning tool for identifying service accounts and/or for distinguishing service accounts from user accounts based on the user names of the accounts.

FIG. 2 illustrates a computing environment that is used to apply a trained machine learning tool for identifying service accounts and/or for distinguishing service accounts from user accounts based on the user names of the accounts.

FIG. 3 illustrates a flow diagram of elements associated with the disclosed embodiments for utilizing machine learning to identify service accounts and/or for distinguishing service accounts from user accounts based on the user names of the accounts in response to identifying the user name of the account.

FIG. 4 illustrates a flow diagram of elements associated with the disclosed embodiments for utilizing machine learning to identify service accounts and/or for distinguishing service accounts from user accounts based on the user names of the accounts, in response to detecting a behavior and/or receiving a request associated with the account.

### DETAILED DESCRIPTION

Disclosed and claimed embodiments are directed to systems and methods for using machine learning to identify service accounts and/or for distinguishing service accounts from user accounts based on the user names of the accounts.

Machine learning tools can be trained on user name label data for a variety of service accounts and user accounts. Then, the trained machine learning tool can be applied to the user names of identified accounts to determine whether the accounts are service accounts or not and, in some instances, without referencing tables or other structures that explicitly identify and distinguish the service/user accounts and/or conventions for identifying service accounts. Then, the systems can respond appropriately, based on the determination of whether the account is a service account or not.

The trained machine learning tool can also be shared with other systems to make the same determinations for their accounts without having to share confidential or proprietary account information.

It will be appreciated that the disclosed embodiments for using the machine learning processes described can be particularly beneficial for addressing many technical problems in the industry. For example, it is a known problem for computer systems to distinguish between user accounts and service accounts. This determination is also critical, in many instances, to ensure appropriate policies and controls are implemented by the computer systems.

While it might be possible for some systems to distinguish/identify service accounts by using simple reference tables, these reference tables introduce their own problems. For instance, reference tables can be generated to track all of the different accounts associated with a system, along with a designation that indicates whether each of the referenced accounts is a user account or a service account. Likewise reference tables can be generated to identify different conventions that are known to be used for specifying an account as a service account, which can be used by a system to evaluate whether those conventions were applied to any of their accounts. However, such reference tables are computationally expensive to maintain, particularly when they have to be updated to reflect and recognize every new convention used for classifying the service accounts and/or every account that is created and used by every different system.

The use of such reference tables can also introduce significant security and privacy concerns, by requiring shared access to the different account information (and proprietary provisioning conventions) between the distributed and external systems that would need this information to make similar determinations of account type.

By utilizing the disclosed embodiments for training and applying machine learning tools to dynamically identify/distinguish service accounts from user accounts based on the account user name, it is possible to avoid the need and use of reference tables for each and every system that needs to identify/distinguish service accounts from user accounts. This is a technical improvement to a technical problem. The disclosed embodiments also enable the trained machine learning tool to comprise a sharable object that can be shared between different systems without having to share reference tables containing confidential account information of the different user accounts (or identification conventions) and without having to train separate machine learning tools for each different system. Again, this represents a technical solution to a technical problem that is created when service accounts are provisioned as specialized user accounts.

It will be appreciated that the determinations of account type may only be predictions, which are not certain to be 100% correct all of the time. However, by training and refining the machine learning tools described herein, it is possible to obtain a very high prediction accuracy. In some instances, the accuracy of the prediction tool has been found to be greater than 90% accurate. This accuracy is sufficiently beneficial to outweigh the potential risks and computational costs associated with creating, managing and sharing reference tables.

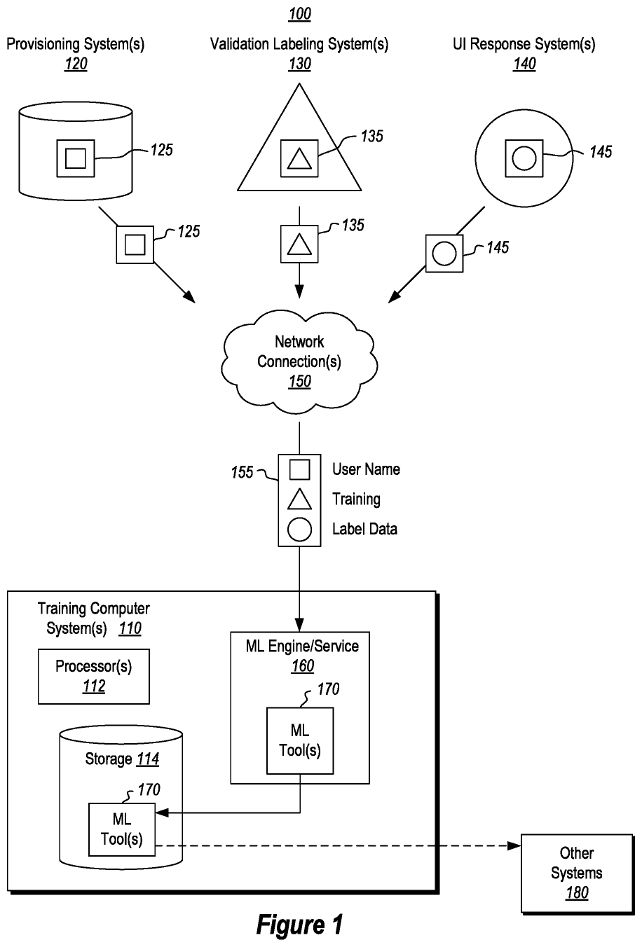

Attention is now directed to FIG. 1, which illustrates a computing environment for training a machine learning tool to identify/distinguish service accounts from user accounts based on the user names of the user/service accounts. The differences between service accounts and user accounts are well-known to those of skill in the art.

As shown, the computing environment 100 includes training computer system(s) 110 in communication with various other systems (e.g., provisioning system(s) 120, validation labeling system(s) 130 and UI response system(s) 140) through one or more network connection(s) 150. These various other systems are configured to generate user name training label data in various formats, which can be used for training machine learning algorithms to identify service accounts and/or to distinguish service accounts from user accounts based on the user names of the various accounts.

By way of example, various provisioning system(s) 120 that were used to create the service accounts may explicitly identify/distinguish the service accounts with information that identifies and/or that associates service accounts with the service account designation. This information can include tags, flags, definitions or other information, as well as the actual service accounts themselves. This information may also be contained in a reference table that maintains a listing of all accounts along with designations or other information for identifying the service accounts in the listing and/or for distinguishing the service accounts from the user accounts in the listing. In some instances, the information identifying the service accounts that is received from the provisioning system(s) 120 is compiled into a single data set of user name training label data 125 that may be composed in different formats to accommodate different machine learning training algorithms.

In another example, various validation and labeling system(s) 130 are used to generate user name training label data 135 which identifies a plurality of different user accounts along with corresponding designations that identify whether each account is a user account or a service account. This information may be compiled as a reference table or other data structure that lists a plurality of different service accounts and user accounts. In some instances, this user name training label data 135 is a document generated from user feedback about a listing of designated user accounts and service accounts, which may also include true positive, false negative, true positive and false negative designations that are generated by the user feedback provided in response to analyzing and validating or invalidating the initial assessments of the various account designations. In such scenarios, the user name training label data 135 may comprise feedback label data generated during supervised machine learning processes.

In yet other embodiments, training data may be received from various UI response system(s) 140 that provide user name training label data 145 as user feedback to specific queries about whether an account is a service account or a user account. For instance, the feedback may comprise express indicators that clarify whether an account is a service account or not in response to a corresponding query about a particular account. Likewise, this feedback may comprise general information for classifying/identifying a plurality of accounts as service accounts (e.g., information that identifies a particular convention that was used by a developer for provisioning/identifying service accounts).

The foregoing user name training data is collectively shown in FIG. 1 as user name training label data 155 for facilitating the description of the disclosed embodiments. In this regard, however, it will be appreciated that this user name training label data 155 may be composed in various formats and structures to accommodate different machine learning methodologies and algorithms. In some instances, the user name training label data 155 received from all of the various provisioning/validation labeling/UI response system(s), is compiled from multiple different formats into a single format. In other instances, the user name training label data 155 is already received from only a single system (or a plurality of systems) in a single format.

While the user name training label data 155 is described as containing user names for the user accounts and service accounts, it will be appreciated that the disclosed embodiments also include, in some instances, user name training label data 155 that comprises or that consists of different types of information that can be used to identify and distinguish between users and services, including, but not limited to a combination of one or more of a title, a phone number, an office location, a designated manager for the user or service dependency, audit logs of user activity, sign-in pattern or resource consumption.

Additionally, in some embodiments, user name training label data 155 may be supplemented with or replaced with audit logs of the user's activity, including at least the time at which a user requests each logon on to a computer system, the name of the resource or application the user was requesting authentication for, and if the request was successful or denied, or other indications of a user's activity, such as electronic mail communications or electronic reservations for meetings, including at least the time, subject, and recipients of electronic mail communications and/or time, location, and subject of meeting reservations on the user's calendar.

Accordingly, in some embodiments, the machine learning tools described herein may also include models/tools that learn from other features of the user account, besides just a user name, and such that the machine learning tools can use a user's title, office location, office phone number, or the user's manager's identity, or any of the aforementioned items, to identify and distinguish between service accounts and user accounts.

In some instances, the user name training label data 155 is converted into a one hot vector that identifies and distinguishes service accounts from user accounts based on the user names of the various accounts. One hot vectors are well-known to those of skill in the art for use with machine learning algorithms. The user name training label data 155 may be converted into the one hot vector (or another usable machine learning format) prior to being received by the training computer system(s) 110, or after.

Although not shown, the computer training system(s) 110 may store the user name training label data 155 in the storage 114 of the computer training system(s) 110.

The storage of the computer training system(s) 110, which may comprise any combination of local and remote storage (as well as volatile and non-volatile storage), further stores computer-executable instructions that are executed by the one or more hardware processor(s) 112 of the computer training system(s) to implement the disclosed embodiments.

As shown, the training computer system(s) 110 also include a machine learning engine/service 160 that maintains and/or trains one or more machine learning tool(s) 170 with user name training label data 155 to enable the machine learning tool(s) 170 to identify/distinguish service accounts from user accounts based on the user name of the service account. The machine learning tool(s) 170 can be stored in the storage 114 of the training computer system(s) 110 and/or shared with one or more other systems 180 for enabling the machine learning tool(s) 170 to be used to identify/distinguish service accounts at various systems.

Notably, the machine learning tool(s) 170 can be shared and used without sharing the user name training label data. The machine learning tool(s) 170 can also be used by various systems (e.g., other systems 180) and without requiring the various systems to reference any tables or other data structures that explicitly identify the user/service accounts by type and/or without having to reference tables or other data structures that explicitly recite the conventions used to identify a service account by a particular system.

The machine learning engine/service 160 and the machine learning tool(s) 170 can incorporate various machine learning algorithms that are known to those of skill in the art. For instance, in some embodiments, the machine learning engine/service 160 and the machine learning tool(s) 170 include or use multilayer neural networks, recursive neural networks, or deep neural networks that are trained with the user name training label data 155 to differentiate between service accounts and user accounts based on user name.

In some embodiments, the machine learning engine/service 160 and the machine learning tool(s) 170 include or use ensemble or decision tree models, such as decision trees, random forests or gradient boosted trees that are trained with the user name training label data 155 to differentiate between service accounts and user accounts based on user name.

In some embodiments, the machine learning engine/service 160 and the machine learning tool(s) 170 include or use linear models such as linear regression, logistic regression, SVMs (support vector machines), etc., which are trained with the user name training label data 155 to differentiate between service accounts and user accounts based on user name.

The machine learning engine/service 160 and the machine learning tool(s) 170 may utilize any of the foregoing machine learning models and techniques.

During the training of the machine learning tool(s) 170, output may be iteratively provided to one or more systems, such as the validation labeling system(s) 130 or UI response system(s) 140, to obtain new, refined or additional user name training label data, such that the machine learning tool(s) 170 are trained with supervised or semi-supervised machine learning.

It will be appreciated, with regard to the foregoing, that the various systems (120, 130 and 140) can be incorporated into the training computer system(s) 110, thereby forming a single stand-alone system or a distributed system for obtaining user name training label data 155 and for developing/training the various machine learning tool(s) 170 that are configured to differentiate between service accounts and user accounts based on user name.

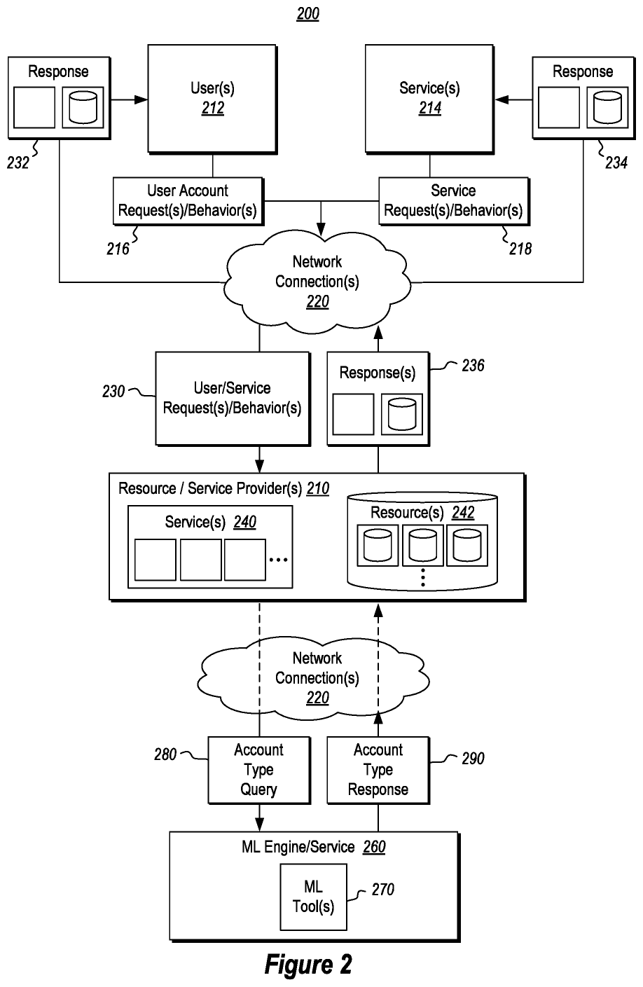

Attention is now directed to FIG. 2, which illustrates a computing system 200 that utilizes machine learning to differentiate between service accounts and user accounts based on user name.

The illustrated computing environment/system 200 may comprise a single distributed computer system, such as a single enterprise computer system or, alternatively, a cloud system that hosts many different tenants/enterprise systems.

In some instances, the computing environment/system 200 may comprise or be incorporated into the aforementioned training computer system(s) 110 or other systems 180 of FIG. 1.

Resource/service provider(s) 210 interface with various user account(s), such as associated with user(s) 212 and service account(s), such as associated with automated service(s) 214 to respond to detected user account requests/behaviors 216 and service account requests/behaviors 218 (collectively referred to as user/service request(s)/behavior(s) 230, which are detected through one or more network connection(s) 220.

The responses (232 and 234) generated by the resource/service provider(s) 210, and which are generated in response to the user/service request(s)/behavior(s) 230, are collectively referred to as response(s) 236. As further described herein, the response(s) 236 are deterministically based on a determination as to whether the user/service request(s)/behavior(s) 230 are determined to correspond to user account(s) or service account(s). These response(s) 236 may include any combination of service(s) 240 and/or other resource(s) 242. The response(s) 236 may also comprise requests for information (e.g., multifactor authentication request) and other content (e.g., anti-virus definitions or instructions) that can be used to initiate or perform remediation of detected harmful or risky user/service request(s)/behavior(s) 230, and which is determined to be appropriate based on the determination of whether the user/service request(s)/behavior(s) 230 correspond to user account(s) or service account(s).

The response(s) 236 may also comprise information that explicitly identifies a designation of an account (such as user account(s) or service account(s)), and which indicates that the account is a service account or a user account. Such a response is particularly appropriate when the user/service request(s)/behavior(s) 230 is a specific request to identify a type of an account and/or in response to detecting a user name for a service/user account.

As also shown in FIG. 2, the resource/service provider(s) 210 determine whether the user/service request(s)/behavior(s) 230 correspond to a user account or a service account by interfacing with a machine learning engine/service 260 (which may comprise machine learning engine/service 160 of FIG. 1) and which uses one or more machine learning tool(s) 270 to evaluate the name of a user account to determine whether that user name corresponds to a service account and/or a user account, as previously described.

The resource/service provider(s) 210 identify the user name of the user account(s) and/or service account(s) by examining the user/service request(s)/behavior(s) 230 which include, in some instances, the user name for the user/service account(s), such as received during a login procedure or other process. In other instances, the user/service request(s)/behavior(s) 230 include other information, such as device identifiers (e.g., device configuration identifiers or IP addresses), that can be used to identify the user/service account(s) and corresponding user names for those accounts.

In some instances, the user/service request(s)/behavior(s) 230 include an object identifier and a tenant identifier that is used to identify the user name of a corresponding account associated with the object identifier and tenant identifier. This user name is provided to the machine learning engine/service 260, through an account type query 280. Then, the user name is applied the machine learning tool(s) 270 to determine the user name corresponds to a service account or, alternatively, that the user name does not correspond to a service account (e.g., by determining the user name corresponds to a user account). This information is then provided by the machine learning service 260 to the resource/service provider(s) 210 for determining an appropriate response to provide, based on the determination of whether the user name corresponds to a user account or service account.

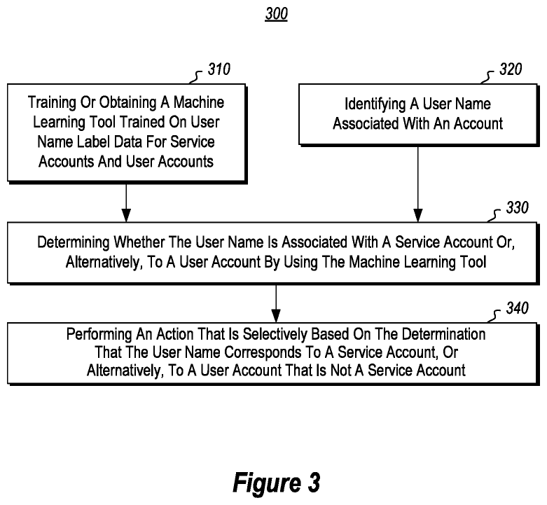

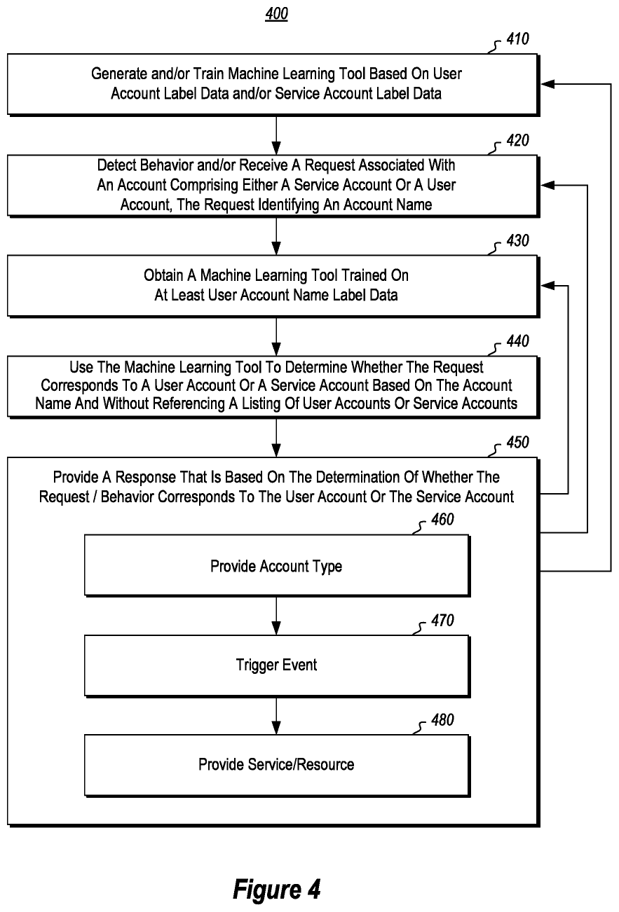

The following discussion now refers to a number of methods and method acts shown in FIGS. 3 and 4, which may be performed to use machine learning to identify a service account and/or to distinguish a service account from a user account, based on a user name of the service account. Although the method acts may be discussed in a certain order or illustrated in a flow chart as occurring in a particular order, no particular ordering is required unless specifically stated, or required because an act is dependent on another act being completed prior to the act being performed.

FIG. 3 illustrates a flow diagram 300 of acts associated with embodiments that are implemented by a computer system (such as system 200 and/or system 110) for facilitating the manner in which service accounts are identified and distinguished from user accounts and, even more particularly, to systems and methods for making service account identifications and predictions based on the user name of the service account.

As shown, the computer system first trains and/or obtains a machine learning tool that is trained on user name label data for service accounts and user accounts (act 310). Next, the system identifies a user name associated with an account (act 320). This may occur while receiving a login request, while receiving a request for services or resources and/or while detecting behaviors associated with an account, as described above. Then, the system determines whether the user name is associated with a service account (act 330). This may be accomplished, for example, by applying the user name to machine learning tool(s) trained to identify service accounts and/or to distinguish between user accounts and service accounts based on user names of the accounts, as described above. Importantly, this determination is accomplished, in some embodiments, without referencing a listing of user accounts or service accounts or the conventions for identifying service accounts, from a reference table or other data structure.

Then, the system performs an action that is selectively based on the determination that the user name corresponds to a service account, or alternatively, to a user account that is not a service account (act 340). In some embodiments, the system performs different actions when the user name is determined to correspond to a service account than other actions that are performed when the user name is determined to correspond to a user account.

For instance, when the system determines that the user name corresponds to a user account, the system may apply a first action (e.g., authorize or deny a user request, lock an account, scan an account, request a multifactor authentication, escalate a user risk profile, provide a user a requested resource or service, and/or other user account specific actions).

Alternatively, when the system determines the user name corresponds to a service account, the system may apply a different action than the first action (e.g., authorize or deny a service request, trigger a service, lock or scan a plurality of user accounts associated with different users, modify a plurality of user accounts, reconfigure an operating system, modify policies or permissions that affect a plurality of user accounts for different users, and/or other service account specific actions).

Attention is now directed to FIG. 4, which illustrates a flow diagram 400 of acts performed by a computer system (such as one or more of the systems described above) for using machine learning to predict whether a user name corresponds to a service account or, alternatively, a user account and for generating a response or for performing another action that is selectively based on the determination of whether a user account corresponds to a service account or, alternatively, a user account.

As shown, the computer system obtains a machine learning tool that is trained on user account name label data (act 430). This machine learning tool may be generated and/or trained by the same computer system or a different computer system that performs the other act(s) recited in FIG. 4, and which is based on user account label data and/or service account label data (act 410).

In some instances, the system obtains the machine learning tool in response to detecting a behavior or receiving a request associated with an account (act 420). The behavior/request may explicitly identify a user name for the account or may contain information that is usable to identify the user name of the account, as described above.

The system uses the machine learning tool to determine whether the request/behavior corresponds to a conventional user account or a service account. In some instances, this is accomplished using a machine learning tool that was trained by another system with user name label data that omits the user name associated with the user/service account making the request/behavior. In some instances, this is also accomplished without examining a reference table that explicitly indicates whether a particular user name is associated with a service account or a user account and without referencing a data structure that explicitly identifies the convention used to distinguish service accounts from user accounts.

Then, in response to the determination of whether the request/behavior corresponds to a user account or a service account, the system provides an appropriate response (act 450), such as by providing output that explicitly identifies the type of the account (460), by triggering an event (e.g., a denial the request, a remediation event or other event) (470), or by providing a requested service or resource (480).

It will be appreciated from the foregoing that the disclosed embodiments can be used to improve on the manner in which computer systems identify and differentiate between user accounts and service accounts and particularly for legacy systems that utilize different classifying conventions for distinguishing between user accounts and service accounts and without having to create, maintain or even reference separate tables that identify the particular account credentials associated with the different user and service accounts and/or the classifying conventions used for distinguishing the service accounts from the user accounts.

It will also be appreciated that the disclosed embodiments may be practiced by a computer system comprising or utilizing a special purpose or general-purpose computer. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A computer system comprising:
one or more processors; and
one or more computer-readable media having stored thereon instructions that are executable by the one or more processors to configure the computer system to implement a method for predicting a service account based on a user name of the service account by performing at least the following:
obtaining a machine learning tool that is trained on user name label data for service accounts and user accounts;
identifying a user name associated with an account comprising either a service account or a user account;
determining whether the user name is associated with the service account in response to applying the user name to a machine learning tool that is trained to identify service accounts and/or to distinguish between user accounts and service accounts based on at least user names of the service accounts; and
performing an action that is selectively based on the determination that the user name corresponds to the service account rather than the user account.

2. The computer system of claim 1, wherein the user name is identified from a login request.

3. The computer system of claim 1, wherein the user name is determined to be associated with the service account without the computer system referencing a reference table or data structure that includes a listing of service accounts.

4. The computer system of claim 1, wherein the user name is determined to be associated with the service account without the computer system referencing a reference table or data structure that explicitly identifies a convention for identifying service accounts.

5. The computer system of claim 1, wherein the method further includes the computer system generating and/or training the machine learning tool to identify service accounts and to distinguish service accounts from user accounts.

6. The computer system of claim 1, wherein the machine learning tool incorporates or utilizes a deep neural network to determine that the user name corresponds to the service account.

7. A computer system comprising:
one or more processors; and
one or more computer-readable media having stored thereon instructions that are executable by the one or more processors to configure the computer system to implement a method for predicting whether a particular account is a service account based on a user name of the particular account by performing at least the following:
detecting a behavior or receiving a request associated with the particular account that comprises either a service account or a user account;
obtaining a machine learning tool trained on at least user name label data;
identifying a user name associated with the particular account;
using the machine learning tool to determine whether the behavior or request corresponds to the user account or the service account and based on applying the user name to the machine learning tool; and
providing a response that is based on the determination of whether the request or behavior corresponds to the service account or, alternatively, the user account.

8. The computer system of claim 7, wherein the detecting the behavior or receiving the request comprises detecting a login request that includes the user name.

9. The computer system of claim 7, wherein the user name corresponds to the service account.

10. The computer system of claim 7, wherein the machine learning tool comprises a deep neural network.

11. The computer system of claim 7, wherein the machine learning tool is generated by and trained by a separate computer system that is different than the computer system that uses the machine learning tool to determine whether the behavior or request corresponds to the user account or the service account by applying the user name to the machine learning tool.

12. The computer system of claim 7, wherein the method further includes the computer system generating and/or training the machine learning tool to distinguish service accounts from user accounts based on user names of the service accounts and the user accounts.

13. The computer system of claim 7, wherein the user name is determined to be associated with the service account without the computer system referencing a reference table or data structure that includes a listing of service accounts.

14. The computer system of claim 7, wherein the user name is determined to be associated with the service account without the computer system referencing a reference table or data structure that explicitly identifies a convention for identifying service accounts.

15. A computer implemented method for predicting whether a particular account is a service account based on a user name of the particular account, the method being performed by a computer system implementing at least the following:
detecting a behavior or receiving a request associated with the particular account that comprises either a service account or a user account;
obtaining a machine learning tool trained on at least user name label data;
identifying a user name associated with the particular account;
using the machine learning tool to determine whether the behavior or request corresponds to the user account or the service account and based on applying the user name to the machine learning tool; and
providing a response that is based on the determination of whether the request or behavior corresponds to the service account or, alternatively, the user account.

16. The method of claim 15, wherein the detecting the behavior or receiving the request comprises detecting a login request that includes the user name.

17. The method of claim 15, wherein the user name corresponds to the service account.

18. The method of claim 15, wherein the machine learning tool comprises a deep neural network.

19. The method of claim 15, wherein the method further includes the computer system generating and/or training the machine learning tool to distinguish service accounts from user accounts based on user names of the service accounts and the user accounts.

20. The method of claim 15, wherein the user name is determined to be associated with the service account while refraining from referencing any reference table or data structure that includes a listing of service accounts or that explicitly identifies a convention for identifying service accounts to determine whether the user name is associated with the service account.
